(19) United States
(12) Patent Application Publication
(10) Pub. No.: US 2010/0183690 A1
(43) Pub. Date: Jul. 22, 2010

(54) Insect Repellent Textile

(75) Inventors: JAIME GISBERT PAYA, ALCOI (ES); MARIA ANGELES BONET ARACIL, ALCOI (ES); PEDRO MATEO RIOBO ABOY, BEAVERTON, OR (US); PABLO MONLLOR PEREZ, ALCOI (ES)

Correspondence Address: ABOY&ASSOCIATES PC;www.aboypatentlaw.com, 522 SW 5th Ave, Suite 1265, Portland, OR, 97204, US

(73) Assignee: INNOVATEC SL, ALICANTE, ALCOI (ES)

(21) Appl. No.: 12/689,222

(22) Filed: Jan. 18, 2010

Related U.S. Application Data
(60) Provisional application No. 61/145,697, filed on Jan. 19, 2009.

(51) Int. Cl. A01N 25/28; A01N 37/18; A01P 7/04; A01N 53/02

(52) U.S. Cl. 424/403; 514/617; 514/531

(57) ABSTRACT

Disclosed embodiments include a textile with insect repellent properties comprising (a) a natural or synthetic fabric, (b) a microencapsulated active ingredient having insect repellent properties, and (c) a resin solution to attach said microencapsulated active ingredients to the fabric. According to a particular embodiment, and without limitation, the insect repellent textile uses a resin solution with a concentration designed to control the degree of wash fastness and gradual release of the microencapsulated active ingredient embedded in the textile in order for it to be gradually released by skin pressure and friction. A plurality of microencapsulated active ingredients could be used including microencapsulated permethrin or toluamide.

### CROSS-REFERENCE TO RELATED APPLICATIONS

This application claims the benefit of U.S. Provisional Application No. 61/145,697 filed on 2000-01-09 by the present inventors, which is incorporated herein by reference.

### BACKGROUND

1. Field of Invention

This invention relates to textiles, fabrics, and garments with insect repellent properties.

2. Related Art

Several inventions related to fabrics with insect repellent properties have been disclosed. For instance, U.S. Pat. No. 5,252,387 discloses an insect repellent fabric. This fabric has a coating containing permethrin and a plasticizer, and a barrier which covers the coating to protect the permethrin from degradation by ultraviolet light and oxygen. The barrier may be an acrylic coating or film, aluminum foil, a urethane coating or film, or an outer fabric barrier such as an awning or a tent fly. U.S. Pat. No. 3,859,121 discloses a formulation for preparing long lasting insect repellent finishes for textile fabrics. In this case, textiles are impregnated with insect repellent compositions including piperonyl butoxide and pyrethrin, wetting agent, thickener and an agent for preventing migration of the pyrethrin and piperonyl butoxide repellent into foods in contact with the textiles and for otherwise retaining the repellent in the textiles.

One of the main difficulties in making textiles with insect repellent properties to be in contact with skin such as bed sheets or clothing is the high toxicity of the active ingredients such as permethrin. These insect repellent active ingredients result in dermatitis and other problems. For this reason, most of these inventions are focused on applications that do not involve direct contact with the skin. For instance, these inventions include insect repelling coatings for textiles such as tents (which are not in direct contact with skin) but cannot be used for bed sheets or clothing.

### SUMMARY

Disclosed embodiments include a textile with insect repellent properties comprising: (a) a natural or synthetic fabric; (b) a microencapsulated active ingredient having insect repellent properties; and (c) a resin to attach said microencapsulated active ingredients to the fabric. According to a particular embodiment, and without limitation, the insect repellent textile uses a resin solution with a concentration designed to control the degree of wash fastness and gradual release of the microencapsulated active ingredient embedded in the textile in order for it to be gradually released by skin pressure and friction. A plurality of microencapsulated active ingredients could be used, including microencapsulated permethrin or toluamide. In one embodiment, the resin used is an acrylic resin with a concentration between 3 to 50 g/l and the microencapsulated permethrin has a concentration greater than 10 g/1.

### BRIEF DESCRIPTION OF THE DRAWINGS

Disclosed embodiments are illustrated by way of example, and not by way of limitation, in the figures of the accompanying drawings.

FIG. 1 shows a block diagram representing the elements comprising the textile with insect repellent properties according to one embodiment.

FIG. 2 shows a block diagram representing the elements comprising the textile with insect repellent properties according to a particular embodiment.

FIG. 3 illustrates the elements comprising a microcapsule (active ingredient and membrane).

FIG. 4 illustrates a fabric with attached microcapsules after thermofixing.

### DETAILED DESCRIPTION

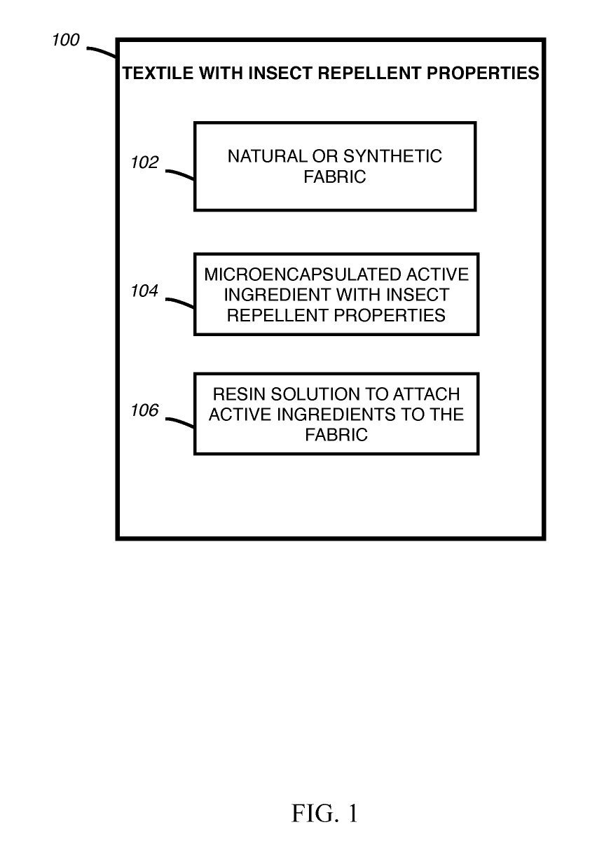

FIG. 1 shows a block diagram representing the elements comprising the textile with insect repellent properties according to one embodiment. Disclosed embodiments include a textile with insect repellent properties 100 comprising: (a) a natural or synthetic fabric 102; (b) a microencapsulated active ingredient having insect repellent properties 104; and (c) a resin to attach said microencapsulated active ingredients to the fabric 106. Such textile can be used to manufacture bed sheets, clothing, or any other garments with insect repellent properties.

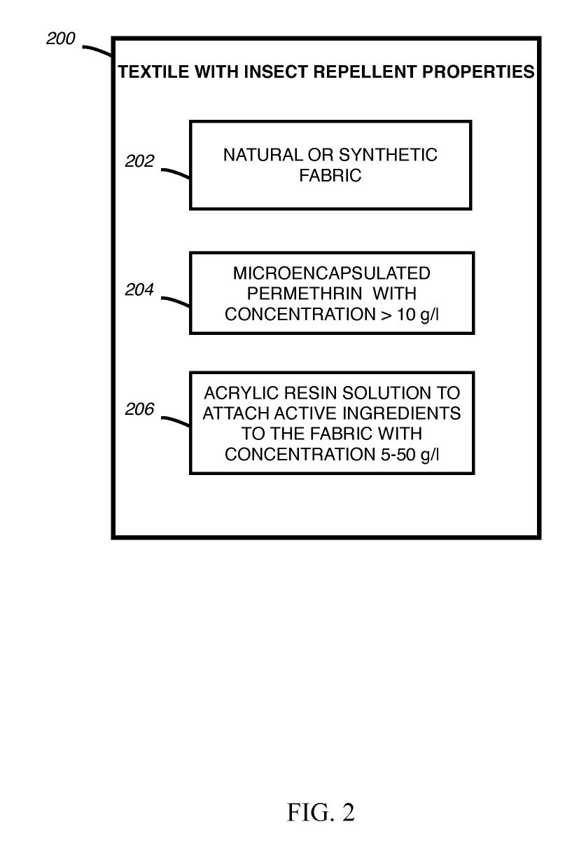

FIG. 2 shows a block diagram representing the elements comprising the textile with insect repellent properties according to a particular embodiment. According to this particular embodiment, and without limitation, the insect repellent textile 200 uses a resin solution with a concentration designed to control the degree of wash fastness and gradual release of the microencapsulated active ingredient embedded in the textile. Higher concentrations result in the microcapsules being fixed to the fabric more strongly. An appropriate concentration is required in order for the active ingredient to be resistant to multiple washes but also capable of being gradually released in small non-toxic amounts by friction with the skin or physical pressure. A plurality of microencapsulated active ingredients could be used including microencapsulated permethrin 204 or toluamide. In one embodiment, the resin used is an acrylic resin with a concentration between 3 to 50 g/l 206 and the microencapsulated permethrin has a concentration greater than 10 g/l 206.

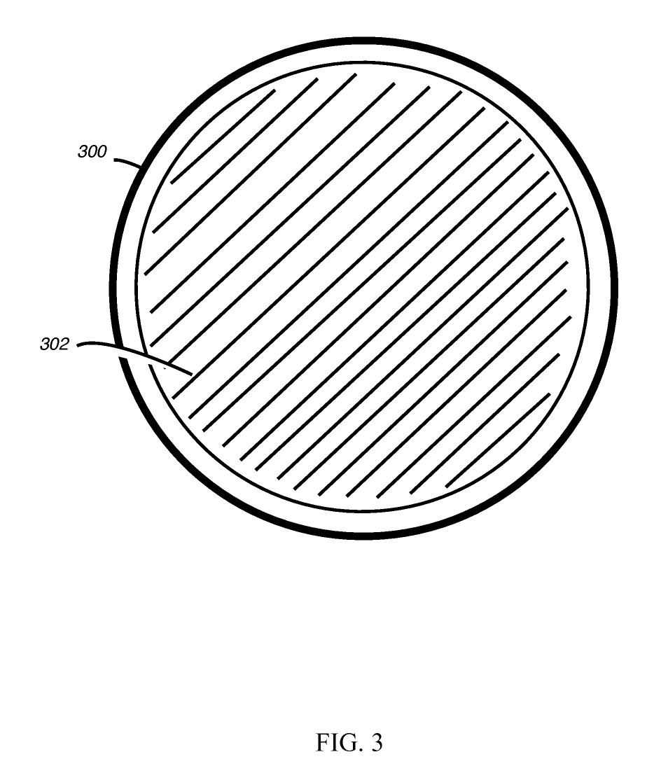

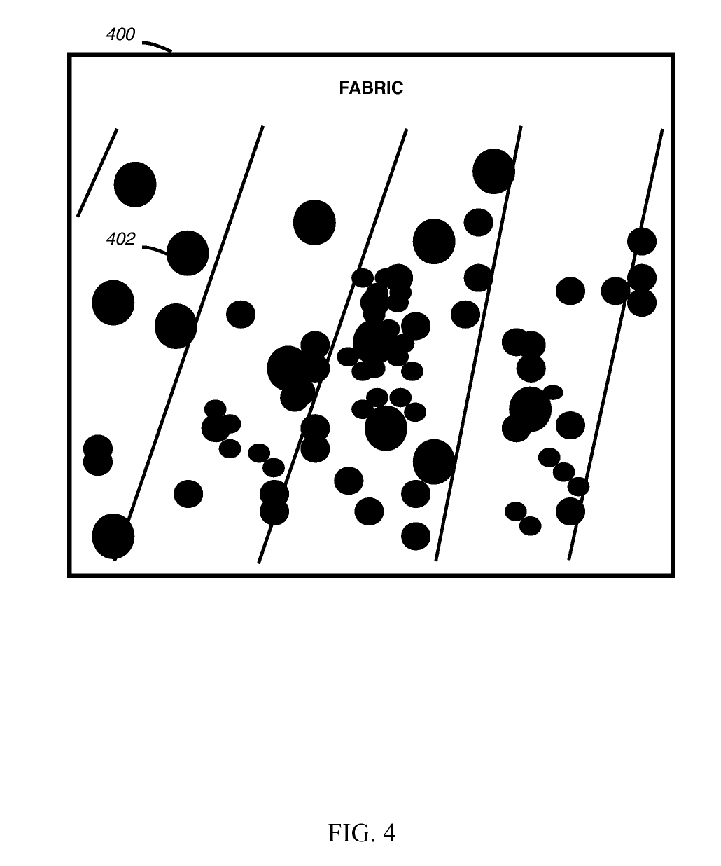

FIG. 3 illustrates the elements comprising a microcapsule (active ingredient 302 and membrane 300). In a particular embodiment the microencapsulated permethrin is created by an emulsification technique such as interfacial polymerization using a high-speed homogenizer to surround permethrin by a membrane intended to prevent direct contact of a high dosage of permethrin with the skin, and enable the gradual release of small quantifies of permethrin during skin friction and contact. In one embodiment the high-speed homogenizer operates between 1000 and 5000 rpm, and the membrane 302 is made of melamine. The microencapsulated permethrin and the resin are combined into a microencapsulated permethrin and resin solution that is thermofixed to the fabric at temperatures between 80 and 180 degrees centigrade. A method of gradual release of microencapsulated active ingredients from a fabric is disclosed. This method comprises: (a) adjusting the concentration of a resin to control the degree of wash fastness and gradual release of the microencapsulated active ingredient in the fabric by skin pressure and friction, and (b) thermofixing the microencapsulated active ingredient in a resin solution to the fabric. FIG. 4 illustrates a fabric 400 with attached microcapsules 402 after thermofixing.

Embodiments of this insect repellent textile can be used in multiple applications such as the prevention of Malaria. According to one embodiment, a method for preventing Malaria comprises: (a) creating a textile with insect repellent properties, said textile comprising a natural or synthetic fabric, a microencapsulated active ingredient having insect repellent properties, and a resin to attach the microencapsulated active ingredients to the fabric; and (b) replacing a traditional textile with the textile with insect repellent properties. For instance, according to one embodiment, the textile is used in bed sheets that incorporate anti-mosquito repellents of the genus Anopheles. The resulting insect repellent sheets can be used to prevent certain diseases such as Malaria.

The above disclosed embodiments can be used to create textiles, fabrics, and garments with insect repellent properties by using microencapsulated permethrin, toluamide, or other active ingredients. The use of microencapsulated permethrin avoids many of the problems associated with the high toxicity of permethrin. These include both skin as well as environmental problems. Embodiments include textiles, fabrics, and garments that incorporate microencapsulated permethrin especially designed by a process whereby permethrin is covered by membranes of melamine formaldehyde in order to protect the direct contact with skin. This helps avoid possible allergies and also problems with the environment. Additionally, the embodiment incorporates a method to control gradual release of permethrin as a result of the rupture of microcapsules in contact with skin. This pressure/friction-based method of gradual release of the microencapsulated active ingredient results in longer lasting insect repellent properties.

A. Microcapsules of Active Ingredient with Insect Repellent Properties.

According to one embodiment, and without limitation, the insect repellent contains DEET (N, N-diethyl-m-toluamide) or permethrin. It has been shown that permethrin is very effective against a variety of insect bites. The main problem of permethrin is that it is toxic in high doses and therefore it is not appropriate due to the fact that constant skin contact results in dermatitis. In order to prevent this side effect, in a particular embodiment we use microencapsulated permethrin. Additionally, the disclosed embodiment incorporates a method to control gradual release of permethrin as a result of the rupture of microcapsules in contact with skin. This pressure/friction-based method of gradual release of the microencapsulated active ingredient results in longer lasting insect repellent properties. According to this embodiment the fabric 400 contains millions of microcapsules 402 per square centimeter. The microcapsules 402 are a scattering of tiny particles or spheres consisting of a membrane or external phase and core or internal phase. The size of the membranes ranges from 0.5 to 150 micrometers. This technique results in very high yields of encapsulation (about 90%), and in non biodegradable microcapsules, thus increasing the persistence of the insecticide, which avoids the need for repeated applications. The membrane 300 surrounds and protects the insect repellent active substance 302 in it. The release of this material is activated by rupture of the membranes 300, by reaction of these with the environment, or permeability of the outer layer. The microcapsules 402 enable the transportation and protection of active substances. The active substance, in this case, permethrin, is released by physical stimuli such as pressure or friction of the microcapsules on the skin, so as to gradually release the active ingredient, producing the effect of repellent. The relationship between fibre and weight bath is much lower than that of the process by exhaustion, between 0.6 and 1.2 liters for every kilogram of textile material. We define this as a process of attrition by which the forces of affinity between the bathroom and the fibre materials in the bathroom become saturated. The relationship between weight and fibre bathroom is fairly high, 1/5 to 1/60.

### B. Microencapsulation Process.

According to one embodiment, the process of microencapsulation of permethrin is made using the technique of interfacial polymerization, obtaining microcapsules of sizes between 3-8 microns and yields above 70%. The active ingredient permethrin is covered by membranes of melamine formaldehyde in order to protect the direct contact with skin and mucous membranes. This helps avoid possible allergies and also problems with the environment. The interfacial polymerization method involves dissolving a hydrophobic monomer in a hydrophobic active material. The mixture is dispersed in a polar phase and a catalyst causes the polymerization of the monomer. The polymer is insoluble in the active substance (hydrophobic) and deposited as a wall around the active substance.

The interfacial polymerization occurs between monomers dissolved in their respective immiscible phases. The soluble monomers are dispersed in the liquid phase by means of agitation, the membrane of the microcapsules is formed by adding an organic monomer soluble in the continuous phase or organic.

According to one embodiment the membrane is formed using two monomers by using melamine and formaldehyde in aqueous phase. Additionally, hydrogen formaldheyde is dissolved slowly with melamine, adding water to form an aqueous solution (A). Such a solution must be completely dissolved with a pH of 9 and an optimum temperature of 70 degrees C. The organic solution (O) of dichloromethane with permethrin and an emulsifying agent are combined at 3000 rpm in a high-speed homogenizer with the water gradually added to the solution in order to react in the interface of two phases to achieve the microencapsulation. Simultaneously, methanol (methyl alcohol) is added as an organic solvent to remove the remains of formaldheyde. In other embodiments the homogenize is operated between 1000 and 5000 rpm.

The microencapsulation of the product takes place in two phases: 1) emulsification, where an emulsion is formed (0/A from an organic phase containing permethrin, along with the thickener and an aqueous phase containing melamine formaldehyde), and 2) polymerization (which occurs as a result of the incorporation of the melamine formaldehyde in the emulsion). These spread to the internal organizational phase in the interface and react, leading to the structure that precipitates encompassing the polymer droplets of the internal phase. The process consists of introducing the microcapsules of permethrin in a bath, whose concentration is approximately 50 g/l (>10 g/l), together with an acrylic resin whose concentration is 15 g/l (ranges between 3-50 g/l are possible). The bath tissue is inserted through a fulard, so that the microcapsules are as homogeneous as possible on the fabric. Finally the microcapsules are attached to the fabric by thermofixing at 100° C. (ranges from 80 to 180 degrees are possible).

While particular embodiments and example results have been described, it is understood that, after learning the teachings contained in this disclosure, modifications and generalizations will be apparent to those skilled in the art without departing from the spirit of the disclosed embodiments.

The invention claimed is:

1. A textile with insect repellent properties, comprising:
(a) a natural or synthetic fabric;
(b) a microencapsulated active ingredient, said microencapsulated active ingredient having insect repellent properties; and
(c) a resin to attach said microencapsulated active ingredients to said fabric.

2. The textile of claim 1, wherein said resin has a concentration designed to control the degree of wash fastness and gradual release of said microencapsulated active ingredient of said textile.

3. The textile of claim 2, wherein said resin has a concentration designed to enable said microencapsulated active ingredient to be released gradually by skin pressure and friction.

4. The textile of claim 3, wherein said microencapsulated active ingredient is microencapsulated permethrin.

5. The textile of claim 3, wherein said microencapsulated active ingredient is microencapsulated toluamide.

6. The textile of claim 3, wherein said resin is an acrylic resin.

7. The textile of claim 6, wherein said acrylic resin has a concentration between 3 to 50 g/l.

8. The textile of claim 4, wherein said microencapsulated permethrin has a concentration greater than 10 g/l.

9. The textile of claim 4, wherein said microencapsulated permethrin is created by an emulsification technique.

10. The textile of claim 9, wherein said emulsification technique is interfacial polymerization.

11. The textile of claim 10, wherein said microencapsulated permethrin is created by said interfacial polymerization with a high-speed homogenizer to surround permethrin by a membrane intended to prevent direct contact of a high dosage of permethrin with the skin.

12. The textile of claim 11, wherein said high-speed homogenizer operates between 1000 and 5000 rpm.

13. The textile of claim 12, wherein said membrane is made of melamine.

14. The textile of claim 13, wherein said microencapsulated permethrin and said resin are combined into a microencapsulated permethrin and resin solution.

15. The textile of claim 15, wherein said microencapsulated permethrin and resin solution is thermofixed to the fabric at temperatures between 80 and 180 degrees centigrade.

16. A method of preventing Malaria, comprising:
(a) creating a textile with insect repellent properties, said textile comprising a natural or synthetic fabric, a microencapsulated active ingredient having insect repellent properties, and a resin to attach said microencapsulated active ingredients to said fabric; and
(b) replacing a traditional textile with said textile with insect repellent properties.

17. A method of gradual release of microencapsulated active ingredients from a fabric, comprising:
(a) adjusting the concentration of a resin to control the degree of wash fastness and gradual release of said microencapsulated active ingredient of said fabric by skin pressure and friction; and
(b) thermofixing said microencapsulated active ingredient in a resin solution to said fabric.
